(19) United States
(12) Patent Application Publication
(10) Pub. No.: US 2021/0193089 A1
(43) Pub. Date: Jun. 24, 2021

(54) REED

(71) Applicant: Nick KÜCKMEIER, Eggersdorf bei Graz (AT)

(72) Inventor: Nick KÜCKMEIER, Eggersdorf bei Graz (AT)

(21) Appl. No.: 16/754,194

(22) PCT Filed: Oct. 25, 2018
(86) PCT No.: PCT/AT2018/060258

§ 371 Date: Apr. 7, 2020

(30) Foreign Application Priority Data
Oct. 27, 2017 (AT) A 50901/2017

(51) Int. Cl. G10D 9/035; C08L 77/02; C08K 3/40; C08K 7/14

(52) U.S. Cl. CPC G10D 9/035; C08K 7/14; C08K 3/40; C08L 77/02

(57) ABSTRACT

A reed for a reed instrument, including a polyamide.

The present invention relates to a reed for a wind instrument. Further, the invention relates to a mouthpiece for a wind instrument, including such a reed. Furthermore, the invention relates to a wind instrument, including a reed. Finally, the invention relates to the use of polyamides for reeds for wind instruments.

### BACKGROUND OF THE INVENTION

Within the group of the reed instruments, so-called reeds are used to produce sounds. Thereby, the reed constitutes the vibrating part of the mouthpiece of the wind instrument. In general, reeds are made from wood, wild cane or common reed (also called giant reed or Arundo donax), less frequently from other natural materials or plastic materials.

There is distinguished between the single reed (single-reed or simply “reed”), which is a pitching tongue, and the double reed (double-reed, “tube”), which is a counter-pitching tongue.

The clarinet is an important representative of the reed instruments. In the clarinet, the reed and the mouthpiece, to which it is attached, form the vibration generator. Apart from clarinets, also saxophones have a single reed. Double-reeds are used, for example, in oboes and bassoons.

Reeds are consumable articles, which have to be prepared rather complexly and may be used only for a limited period of time. Furthermore, the condition of the reeds may rapidly change, having immediate effects on the sound of the instrument. Reeds may change when being played and in the case of temperature changes, and they are subject to an aging process, leading to the reed becoming “softer”, developing cracks or bloating until it cannot be used any longer.

After harvesting, reeds made from common reed have to be stored for at least two years in order to harden. Subsequently, rectangular and flat pieces are cut therefrom according to the dimensions and sizes of the individual instruments and ground into the appropriate shape.

For clarinets, for example, a piece at the bottom side is machined and ground to complete planeness. At the top side, it is levelled out at an end to 0.08 mm, wherein the tolerances with about 1/1000 mm are extremely low. The reed has to have a certain rigidity, it has to be elastic and has to have symmetrical vibration characteristics. Natural products, however, are subject to fluctuations due to growth and environmental influences, such that there will be present differences between the individual reeds. Furthermore, new reeds have to be attuned to playing according to the instrument and user of the instrument, which is frequently associated with high effort and limitations in the period of use. Reeds are partly stored in air-conditioned boxes in order to maintain the reeds within a constant environment of moisture and/or temperature.

In an effort to reduce the problems arising with the naturally grown reeds, it was attempted to use plastic as a starting material for reeds. Plastics should have a permanently constant response behaviour and should age less rapidly. Numerous tests, for example, with polymethyl methacrylate (PMMA) as a starting material, were unsuccessful as PMMA has poor vibration characteristics. In order to improve the vibration characteristics, there were tested composite materials, e.g., made from carbon fibres with synthetic resins (carbon fibre reinforced plastics) (Fiberreed and Vibracell). Whereas the processability of these composite materials is good, professional musicians experience the reeds made therefrom as being too rigid in the vibration behaviour. Furthermore, the food-safety of these materials is rather unclear, as carbon fibre reinforced plastics are in part considered as being critical.

As an alternative to PMMA, there has also been used polypropylene as a material for reeds, for example, by Légère Reeds Ltd. Canada. Polypropylene, however, may only be machined using diamond tools due to the high surface tension thereof, and it is water resistant, which results in a sharp bright sound, especially in the forte. The incorporation of ground bamboo dust as a filler within the polypropylene (FORESTONE JAPAN Co., Ltd.) has not significantly improved the sound characteristic of the material. Professional musicians, for this reason, have turned away from plastic reeds.

DE 89 04 968 U1 describes reeds made from internally reinforced or externally reinforced plastics (e.g., by fibres). In particular plastics, which may be obtained by stretching the polymers, are to improve the material and sound characteristics.

### DESCRIPTION OF THE INVENTION

For the specific sound and the play characteristics of the single-reed instruments (such as clarinet or saxophone) and double-reed instruments, the growth of the reed wood, the fibres (xylenes), the individual specific geometry, well-balanced vibration characteristics, the hardness and elasticity as well as the moisture balance of the reed tongue are rather decisive. Prior art, however, has not been able to solve this problem so far.

It is, hence, the object of the present invention to provide a reed, which has sound characteristics like a common reed with constant sound quality.

This task is solved by a reed, including a polyamide of the group

PA a, PA b.c or PA d-T or a mixture (blend) thereof,
wherein a≥10, b≥6, c≥10, d≥9.

In the nomenclature common for polyamides, the polyamides are distinguished into AB polymers and AA/BB polymers. The AB polymers include such having the following basic structure:

—[NH—(CH₂)ₓ—CO]ₙ—.

If x=5, then we refer to PA 6, as the repeating unit has 6 carbon atoms. If x=9, then we refer to PA 10, and if x=11, then we refer to PA 12. In the diction above, in the case of a=10 we have PA 10.

The AA/BB polymers includes such having the basic structure

[NH—(CH₂)ₓ—NH—CO—(CH₂)_{y}—CO]ₙ—.

If x=6 and y=8, then we refer to PA 6.10, as the repeating first unit has 6 carbon atoms and the repeating second unit has 10 carbon atoms.

For the AA/BB polymers, there are also such, wherein the —(CH₂)_{y}— unit is replaced by terephthalate (T). In the case of PA 9-T, we thus refer to —(CH₂)₉— with subsequent terephthalate.

Examples of the polyamides mentioned above are as follows:

### PA 6.12, PA 6.10, PA 6.11, PA 10, PA 12, PA 11, PA 9-T, PA 10.10, PA 11, PA 12.12.

Especially suitable polyamides are PA 6.12, PA 6.10, PA 6.11, PA 10 or PA 12, in particular PA 6.12, PA 6.10 and PA 6.11.

During the analysis of various materials, it has surprisingly been shown that only special polyamides have the desired sound characteristics corresponding to those of common reeds. Such reeds are suitable especially also for professional musicians.

The content of polyamides is preferably at least 25% by weight, especially preferably at least 50% by weight, most preferably at least 60% by weight. In one embodiment the reed is composed of polyamide of the type mentioned above.

Especially preferably, there is made the provision that the reed has a water absorption of 0.1% to 2%, preferably 0.7% to 0.8%, according to ISO 62:1999. Polyamides have, depending on the polymer set-up, different characteristics in regard to water absorption. The common polyamides PA 6, PA 6.4 and PA 6.6 may, for example, absorb up to 8% water, which leads to the reed made from PA 6, PA 6.4 or PA 6.6 changing their sound when played for a longer period of time, thus not being suitable.

Suitable polyamides are, for example, PA 6.12, PA 6.10, PA 6.11, PA 10 or PA 12, as these polyamides have the characteristic that they allow a maximum change of weight of 1% through moisture absorption.

There may further be provided that the reed has additives. These in particular serve for the mechanical reinforcement (reinforcement material) of the reed. There may, for example, be added glass fibres. The maximum proportion of additives is 40% by weight, on the basis of the entire reed. In order to provide well-balanced sound at very good rigidity, 22 to 40% by weight have proven to be optimal. The additives may also serve for regulating the moisture balance. The additives are preferably glass fibres. The glass fibres used in die casting have a length between 0.1 and 5 mm, being present in the granules for the die casting. Such glass fibres having a content of up to 40% by weight, preferably 22 to 40% by weight, are especially suitable.

In a preferred exemplary embodiment the reed is composed of a polyamide of the type mentioned above as well as glass fibres, wherein the proportion of glass fibres is up to 40% by weight, with the remainder being polyamide. Especially preferably the proportion of glass fibres is between 22 and 40% by weight, with the remainder being polyamide. Preferably, the polyamide is selected from the group consisting of PA 6.12, PA 6.10, PA 6.11, PA 10, PA 12, PA 11, PA 9-T, PA 10.10, PA 11, PA 12.12, especially preferably from the group consisting of PA 6.12, PA 6.10, PA 6.11, as well as blends thereof.

Within the scope of the invention, a reed is understood as a single-reed as well as a double-reed.

Single-reed means that not the entire tube but rather a levelled piece of the tube is used, which is attached to an appropriate mouthpiece. When blowing into the tube, there are generated vibrations. In contrast thereto, oboes and bassoons have double-reeds. With double-reeds, the entire piece of tube is used, cut in the longitudinal direction and then pressed together. The two ends are then levelled, similar as with the clarinet reed, only on both sides. Thus there is developed the counter-piece to the clarinet reed with mouthpiece. This double-reed is the complete sound generator, whereas the instrument is merely the resonator. Machining the double-reeds is substantially more complex than that of the single-reeds, which is why an industrial production is substantially more expensive.

The present invention relates, apart from the reed described above for a wind instrument, also to a mouthpiece for a wind instrument, including such a reed.

Furthermore, the invention relates to a wind instrument, including such a reed or a mouthpiece having such a reed, respectively.

Finally, the invention relates to the use of polyamides for reeds for wind instrument. The polyamides preferably have a moisture absorption according to ISO 66 of 0.1 to 2% by weight, preferably 0.7 to 0.8% by weight.

The production of reed may, for example, be realized using die casting, by pellets of polyamide, optionally with additives, being plasticized in an extruder and subsequently injected into a die, wherein the die essentially corresponds to the finished reed. Optionally, there is subsequently carried out grounding into the finished reed. As an alternative, the production may be realized using film extrusion, wherein the pellets of polyamide, optionally with additives, are plasticized in an extruder and subsequently discharged via a flat nozzle such that there is developed a film or plate, respectively. From the film or plate there are then cut out blanks and then ground into the finished reed.

In contrast to other plastics, the plastics according to the invention may be manually post-processed. They may be ground and scraped, which has not been possible so far with commercially available reeds made from plastics. This is advantageous if the musician wants to tailor the reeds according to his/her requirements. In particular with reeds made from polypropylene with (FORESTONE JAPAN Co., Ltd.) and without (Légère Reeds Ltd, Canada) ground bamboo dust as a filler, such a post-processing is more or less impossible.

Plastic materials, which have successfully been analysed, comprise PA 6.12, PA 6.10, PA 6.11, PA 10 or PA 12, respectively with or without glass fibre additives.

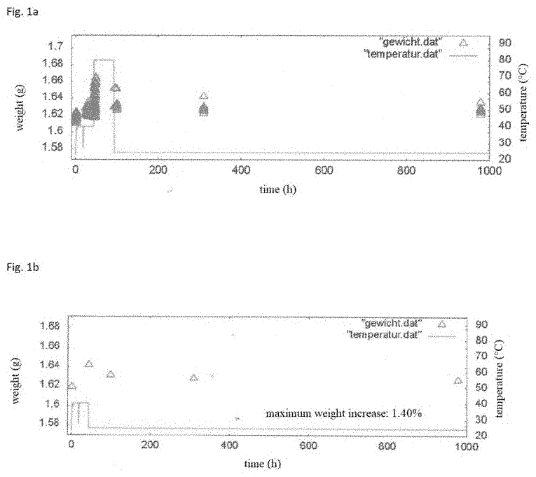

FIGS. 1a and 1b show water absorption data of reeds made from PA 6.6.

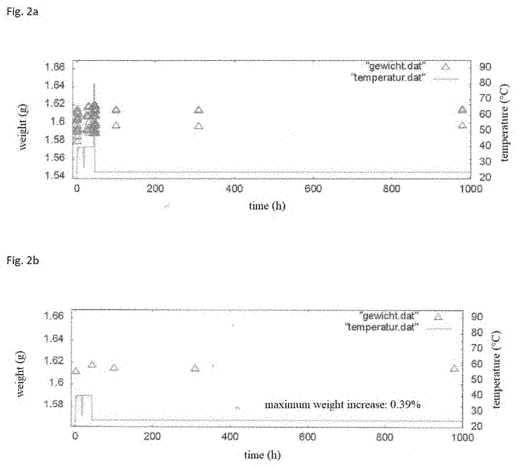

FIGS. 2a and 2b show water absorption data of reeds made from PA 6.12.

In FIG. 1a to 2b there is shown the water absorption of reeds made from polyamides. FIGS. 1a and 1b show reeds made from PA 6.6 with glass fibre additives, whereas FIGS. 2a and 2b show reeds made from PA 6.12 with glass fibres. In the respective upper diagram (FIG. 1a or 2a, respectively), there is shown the conditioning at 80° C., wherein there may be seen that the water proportion absorbed will remain constant already after a short period of time.

In the respective lower diagram (FIG. 1b or 2b, respectively), there is shown the water absorption at 40° C. conditioning, which corresponds approximately to the environment of the reed within the musician's mouth. Also here, there is realized for a short term a higher water absorption, which will eventually, however, remain constant.

In the case of PA 6.6 with glass fibre additives, the maximum water absorption at 80° C. was up to 2.82% by weight. In the case of PA 6.12 with glass fibre additives, however, the water absorption at 80° C. was at the most 0.70% by weight.

For this reason, the musician may grind and process these products similarly to the wooden reed, and as soon as he/she puts it into his/her mouth, they will absorb a certain moisture proportion, similar to the wooden reed, which will remain constant after short play-tuning. Similarly, this condition may be pre-simulated by way of conditioning. A low moisture absorption is decisive for a high sound quality, as it renders the material elastic when vibrating and thus gets closest to the common behaviour of a wooden reed.

In the case of PA 6.12 the weight increase is between 0.05 and 0.70% by weight. This material, hence, is more stable, creating more constant ratios in comparison to PA 6.6. The data of PA 6.10, PA 6.11, PA 10 or PA 12, which are comparable to those of PA 6.12, are not shown.

1. A reed for a reed instrument, comprising a polyamide of the group:
PA a, PA b.c, or PA d-T
or a mixture (blend) thereof,
wherein a≥10, b≥6, c≥10, d≥9.

2. A reed according to claim 1, wherein the reed has a water absorption of 0.1% by weight to 2% by weight, according to ISO 62.

3. A reed according to claim 1, wherein the polyamide is selected from the group consisting of PA 6.12, PA 6.10, PA 6.11, PA 10, PA 12, PA 11, PA 9-T, PA 10.10, PA 11, PA 12.12.

4. A reed according to claim 3, wherein the polyamide is selected from the group consisting of PA 6.12, PA 6.10, PA 6.11.

5. A reed according to claim 1, further comprising one or more additives.

6. A reed according to claim 5, wherein the reed comprises 22 to 40% by weight of the one or more additives.

7. A reed according to claim 5, wherein the one or more additives include glass fibres.

8. A reed according to claim 1, wherein the reed is composed only of the polyamide and glass fibres.

9. A reed according to claim 8, wherein the proportion of glass fibres is in amounts up to 40% by weight, wherein the remainder is the polyamide.

10. A reed according to claim 1, wherein the reed is a single reed or a double reed.

11. A mouthpiece for a wind instrument, comprising the reed according to claim 1.

12. A wind instrument, comprising the reed according to claim 1.

13. A method of manufacturing a reed for reeds for wind instruments, comprising forming a polyamide into a reed, wherein the polyamide is of the group:
PA a, PA b.c, or PA d-T
or a mixture (blend) thereof,
wherein a≥10, b≥6, c≥10, d≥9.

14. A reed according to claim 2, wherein the reed has a water absorption of 0.7% by weight to 0.8% by weight, according to ISO 62.

15. A reed according to claim 9, wherein the proportion of glass fibres is between 22% and 40% by weight, wherein the remainder is the polyamide.

16. A wind instrument, comprising the mouthpiece according to claim 11.
